(19) United States
(12) Patent Application Publication
(10) Pub. No.: US 2010/0306321 A1
(43) Pub. Date: Dec. 2, 2010

(54) DELIVERING MESSAGES USING USER-DEFINED AGENTS

(75) Inventors: Saeed Noursalehi, Redmond, WA (US); Victor William Habib Boctor, Redmond, WA (US); Jeffrey Brian Kay, Bellevue, WA (US); Todd Carlyle Luttinen, Redmond, WA (US)

Correspondence Address: MERCHANT & GOULD (MICROSOFT), P.O. BOX 2903, MINNEAPOLIS, MN, 55402-0903, US

(73) Assignee: MICROSOFT CORPORATION, Redmond, WA (US)

(21) Appl. No.: 12/475,374

(22) Filed: May 29, 2009

(51) Int. Cl. G06F 15/16; G06F 13/00

(52) U.S. Cl. 709/206; 709/230; 709/238; 719/328

(57) ABSTRACT

User-defined agents and connectors are defined to process messages for a messaging application. The user-defined agents are configured to extend the capabilities of the messaging application. Each user-defined agent is associated with a connector that is configured to route messages for a particular address space according to the specified protocol. Upon receipt of a routed message within the particular address space, the messaging application on the server invokes the associated user-defined agent to process the message. The user-defined agent utilizes an API that is associated with the messaging application to assist in processing the message.

### BACKGROUND

Messaging systems typically include server components and client components. In order to facilitate communications of the messages between the components, the components agree on a communications protocol. The agreed upon protocol sets out the rules defining the expected behavior of each party during communications. Different messaging systems agree upon different protocols.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

User-defined agents and connectors are defined to process messages for a messaging application. The user-defined agents are configured to extend the capabilities of the messaging application. For example, a user-defined agent and connector may be created that adds the ability to process messages according to a protocol that is not natively supported by the messaging application. Each user-defined agent is associated with a connector that is configured to route messages for a particular address space according to the specified protocol. Upon receipt of a routed message within the particular address space, the messaging application on the server invokes the associated user-defined agent to process the message. The user-defined agent utilizes an API that is associated with the messaging application to assist in processing the message as well as provide information regarding the processing to the messaging application.

### BRIEF DESCRIPTION OF THE DRAWINGS

FIG. 1 illustrates a computer architecture for a computer;

FIG. 2 shows an example messaging system using user-defined agents for processing messages;

FIG. 3 illustrates a process for initializing a messaging application using user-defined agents;

FIG. 4 shows a process for processing messages using a user-defined agent;

FIG. 5 illustrates a process for opening a connection for a protocol supported by a user-defined agent;

FIG. 6 shows a process for delivering messages using a user-defined agent; and

FIG. 7 illustrates a process for closing a connection that is associated with a user-defined agent.

### DETAILED DESCRIPTION

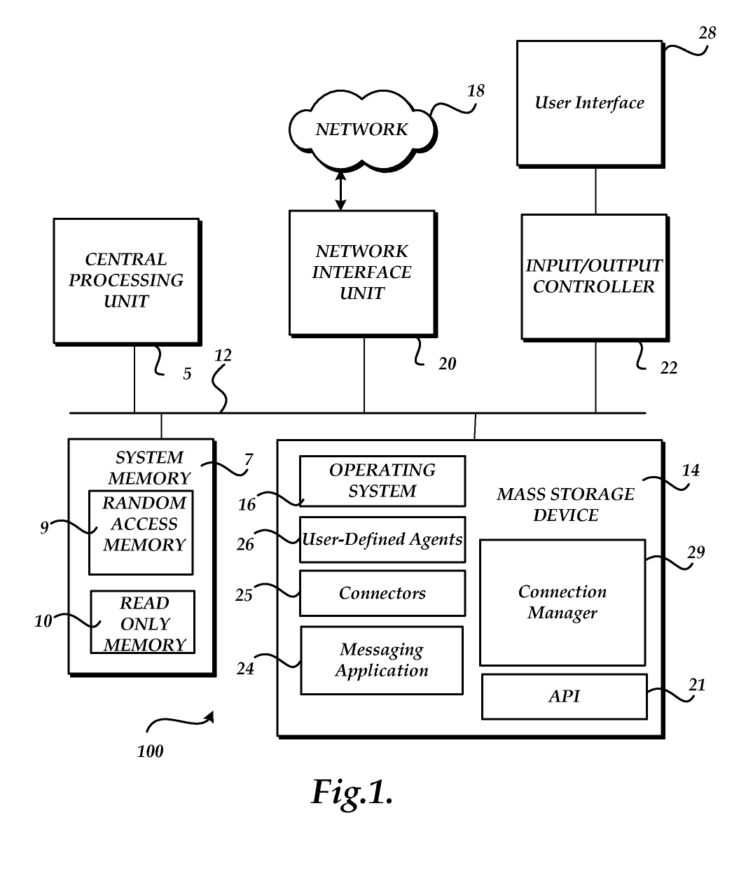

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a server (e.g. a messaging server), a desktop, or mobile computer and includes a central processing unit 5 (“CPU”), a system memory 7, including a random access memory 9 (“RAM”) and a read-only memory (“ROM”) 10, and a system bus 12 that couples the memory to the CPU 5. A basic input/output system containing the basic routines that help to transfer information between elements within the computer, such as during startup, is stored in the ROM 10. The computer 100 further includes a mass storage device 14 for storing an operating system 16, application programs, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide output to a display screen that includes a user interface 28, a printer, or other type of output device. User interface (UI) 28 is designed to provide a user with a visual way to interact with messaging application 24, as well as develop one or more user-defined delivery agents.

As mentioned briefly above, a number of program modules and data files may be stored in the mass storage device 14 and RAM 9 of the computer 100, including an operating system 16 suitable for controlling the operation of a networked computer, such as the WINDOWS SERVER 2008® operating system from MICROSOFT CORPORATION of Redmond, Wash. The mass storage device 14 and RAM 9 may also store one or more program modules. In particular, the mass storage device 14 and the RAM 9 may store one or more application programs. One of the application programs is a messaging application 24, such as MICROSOFT EXCHANGE SERVER 2010®.

Generally, messaging application 24 is configured to process messages to/from various network locations. Connection manager 29 is configured to manage user-defined agents 26 and connectors 25 while processing messages for messaging application 24. Each user-defined agent 26 is created to process messages according to a specified protocol within a particular address space. Generally, user-defined agents are created to process messages according to a protocol that is not natively supported by the messaging application 24. For example, messaging application 24 may be natively configured to process messages using a first and a second protocol, whereas a user-defined agent may be configured by a third-party to process messages using a third protocol. Similarly, one or more user-defined agents may be configured to process messages using the same protocol as other agents but utilize a different address space. Each user-defined agent 26 is associated with a connector 25 that is configured to route messages for a particular address space according to the specified protocol. Upon receipt of a routed message within the particular address space, the connection manager 29 invokes the associated user-defined agent 26 to process the message. The invoked agent utilizes an API 21 that is associated with the messaging application 24 to assist in processing the message. Generally, API 21 provides user-defined agents 26 the same access to messaging processing functions as a native agent and connector. For example, a user-defined agent may utilize API 21 for queue managements and diagnostics (i.e. message tracking, connection logs, latency tracking).

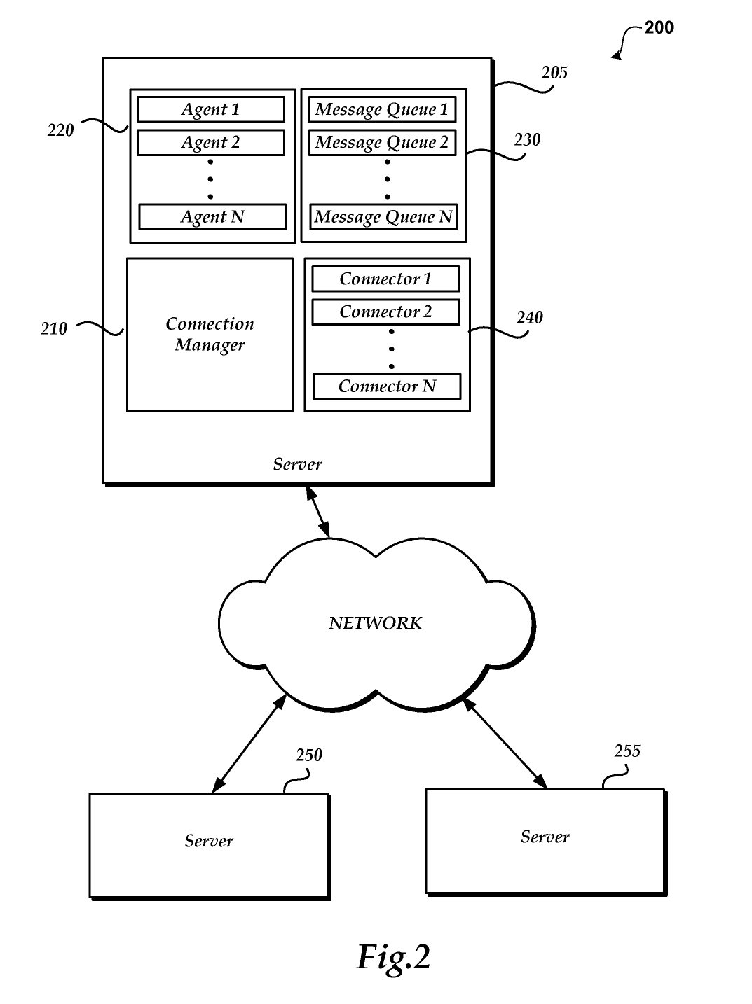

FIG. 2 shows an example messaging system using user-defined agents for processing messages. As illustrated, system 200 includes messaging servers 205, 250 and 255. Server 205 as illustrated includes user-defined agents 1-N (220), connectors 1-N (240), message queues 1-N (230), and connection manager 210. Servers 250 and 255 may be similarly configured as server 205. System 200 may include more servers and/or client computing devices that are configured to process electronic messages.

As discussed above, connection manager 210 assists the messaging application in managing user-defined agents 220, connectors 240, and message processing from queues 230. Each user-defined agent within agents 220 processes messages according to a specified protocol within a particular address space.

According to one embodiment, each user-defined agent 220 is derived from an base class that exposes three events including an open connection event, a deliver mail event, and a close connection event. When the user-defined agent is defined the delivery protocol that it supports is specified. The specified delivery protocol is used by connection manager 210 in selection of the available user-defined agents when processing a message. The following are exemplary definitions relating to a user-defined agent.

```
    public class FooDeliveryAgentManager : DeliveryAgentManager
  {
    public override string SupportedDeliveryProtocol
    {
      get { return “foo”; }
    }
  }
  public class FooDeliveryAgentFactory
DeliveryAgentFactory<FooDeliveryAgentManager>
  {
    public override DeliveryAgent CreateAgent(SmtpServer server)
    {
      return new FooDeliveryAgent( );
    }
  }
  public class FooDeliveryAgent : DeliveryAgent
  {
    public FooDeliveryAgent( )
    {
      this.OnOpenConnection += new
OpenConnectionEventHandler(this.OnOpenConnectionHandler);
      this.OnDeliverMailItem += new
DeliverMailItemEventHandler(this.OnDeliverMailItemHandler);
      this.OnCloseConnection += new
CloseConnectionEventHandler(this.OnCloseConnectionHandler);
    }
    private void
    OnOpenConnectionHandler(OpenConnectionEventSource
source, OpenConnectionEventArgs e)
    {
      // TODO: open a connection
    }
  private void OnDeliverMailItemHandler(DeliverMailItemEventSource
source, DeliverMailItemEventArgs e)
    {
      // TODO: deliver a mail item
    }
  private void OnCloseConnectionHandler(CloseConnectionEventSource
source, CloseConnectionEventArgs e)
    {
      // TODO: close the connection
    }
  }
```

The open connection event occurs when connection manager 210 determines that there is a message with a next hop type equal to one of the user-defined agents and the number of active invocations for the user-defined agent is zero. According to another embodiment, the open connection event may occur when ActiveQueueLength/ActiveConnections is greater than a MaxMessagesPerConnection and a total number of active invocations are less than MaxConcurrentConnections defined on an AgentConnectorConfig class.

A user-defined agent that has registered for the open connection event for a specific delivery protocol that matches the connector associated with one of the queues is activated.

According to one embodiment, if a user-defined agent does not call a Register Connection method provided by the API for communication with the messaging application after invocation, the associated queue for the user-defined agent is placed into a RETRY state with an error message indicating that no user-defined agent processed the queue (“No agents handled the queue”).

The deliver mail event occurs after an agent that was previously invoked for the open connection event has called the Register Connection method and has not called a Defer Queue or Fail Queue method. The deliver mail event occurs each time the connection manager 210 gets the next mail item in the associated queue and makes the agent aware that a message is available for delivery. According to one embodiment, one event is generated for each message to be delivered. During delivery, the agent acknowledges delivery status of the message back to the messaging application using the API. This information may then be used by messaging application to assist in managing the processing of the messages. In addition, if the agent encounters a transient or permanent failure on the connection it has with the remote system it notifies connection manager 210 that the connection is no longer available.

If the user-defined agent that is invoked returns without acknowledging that the message has been processed (AckMailItemSuccess, AckMailItemDefer, AckMailItemFail, DeferQueue, FailQueue methods not called), the message status within the queue is changed to “RETRY” with an error set to “Agent returned without processing message”. According to one embodiment, a default time span is used to defer action (e.g. 1 minute, 2 minutes, 5 minutes and the like). The user-defined agent also has the option to acknowledge delivery to individual recipients on the mail item rather than acknowledging the entire message at once. This can be useful for protocols (such as fax and SMS) where the message is delivered independently to each recipient. The methods for ack'ing a recipient include AckRecipientSuccess, AckRecipientDefer, and AckRecipientFail.

Messages processed using user-defined agents are treated similarly to messages using the messaging applications default native delivery agents. As such, messages may be tracked and have associated log events even when the protocol is not a protocol initially supported by the email server. According to one embodiment, the messaging application uses Simple Mail Transfer Protocol (SMTP) technology as its default method to deliver messages to and from the Internet. SMTP is a member of the TCP/IP suite of protocols that governs the exchange of e-mail. One or more user-defined agents may be defined that extend the protocols supported by the messaging application. According to one embodiment, the delivery agents are defined by third-parties.

A user-defined agent may specify any protocol including but not limited to: SMTP connectors, FAX connectors, SMS connectors, X.400 connectors, non-standard protocol connectors, and the like. A user, such as an administrator, can view and manage queues of messages that are being sent over a non-SMTP protocol using the same queue viewing tools as for all other messages handled using native protocols. Similarly, operations like suspending queues, rejecting messages in a queue, etc, all work.

The close connection event occurs when connection manager 210 determines that there are no more messages available in the queue for the agent and the agent has not previously called DeferQueue, FailQueue or UnRegister Connection methods provided by the API. When invoked, the agent closes the network connection(s), acknowledges to the messaging application that the connections have been closed by calling the UnRegisterConnection method provided in the API and returns. If the agent returns without calling the UnRegisterConnection method or no event handler is registered for the close connection event, the messaging system unregisters the connection.

On a service shutdown, the close connection event may be raised if a registered connection exists. This allows for the agent to gracefully close any connections it has with remote systems.

Each user-defined agent can define the threshold of messages within an associated queue at which multiple connections are invoked, as well as the maximum number of connections for that connector. When processing a queue, the connection manager 210 creates a new connection if there are more messages per existing connection than defined by the threshold, and if creating a new connection does not exceed the maximum number of connections.

The message queue 230 may contain one or more different queues. For example, all of the messages may be stored within a single queue, or messages may be stored in different queues. According to one embodiment, each type of delivery agent has an associated message queue. Each message queue is a temporary holding location for messages that are waiting to enter the next stage of processing. According to another embodiment, the queuing of messages may be controlled by the connector configuration. In this example, a single queue is created for each instance of a delivery agent connector. In this way, an authorized user, such as an administrator has the choice of creating a single connector that handles the entire address space for a protocol (resulting in a single queue), or they may choose to break up the address space with multiple connectors (resulting in multiple queues).

According to one embodiment, the messaging application does not consider the message as having been delivered until it is fully processed by the associated user-defined agent and is reported to the messaging application as having been delivered to a remote system. As a result, the message tracking logs contain an accurate representation of what has happened to a message that was delivered over non-native protocols.

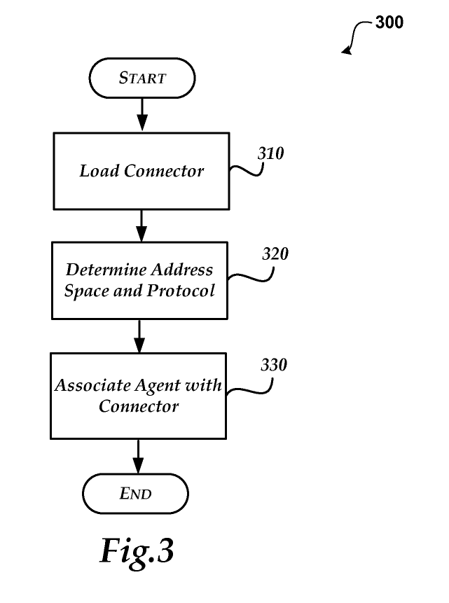

Referring now to FIGS. 3-7, illustrative processes for using user-defined agents for processing messages is described.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

FIG. 3 illustrates a process for initializing a messaging application using user-defined agents.

After a start operation, the process flows to operation 310, where each defined connector is loaded by the messaging application. According to one embodiment, each connector defines an address space and a delivery protocol. Other definitions may be included, such as the maximum messages for a connection as well as the maximum concurrent connections. The address-space defines the address space that the user-defined agent connector supports. The address space is used by the messaging application to locate a connector matching a recipient routing address. The delivery protocol property indicates the protocol supported by the connector. This is used by the messaging system to invoke only those agents that “advertise” a delivery protocol that matches the connector delivery protocol property value. The maximum messages per connection property indicate a maximum number of messages that will be delivered over an agent invocation. This property is the maximum number of deliver mail events that are raised to the associated deliver mail handler for the user-defined agent. The maximum concurrent connections property indicates the maximum number of concurrent agent invocations that can occur for an agent. This is the maximum number of open connection events that will be raised to the associated open connection event handler for the agent.

Moving to operation 320, the address space and the protocol for the connector is determined.

Flowing to operation 330, one or more agents are associated with the loaded connector. The agent(s) is selected based on the protocol supported by the agent as compared to the connector's protocol and the address space of the agent as compared to the address space of the connector.

The process then flows to an end operation and returns to processing other actions.

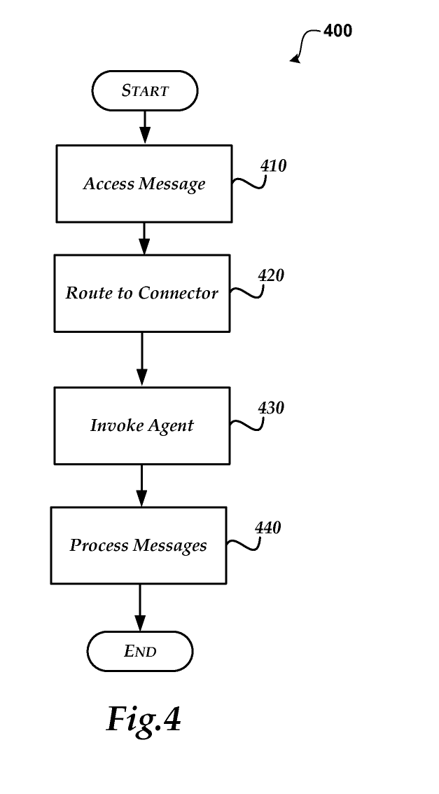

FIG. 4 shows a process for processing messages using a user-defined agent.

After a start operation, the process flows to operation 410, where a message is accessed. According to one embodiment, the message is accessed from a queue that is associated with the messaging system.

Moving to operation 420, the message is routed to the appropriate connector. The connector is selected based on the address space and protocol.

Flowing to operation 430, the agent(s) that is associated with the connector is invoked. Invoking the agent, the agent may perform various operations based on the event raised by the messaging system.

Transitioning to operation 440, the messages are processed by the selected user-defined agent. During processing of the messages, the user-defined agent utilizes functionality supplied by a third party as well as functionality provided by an API that is associated with the messaging application.

The process then flows to an end operation and returns to processing other actions.

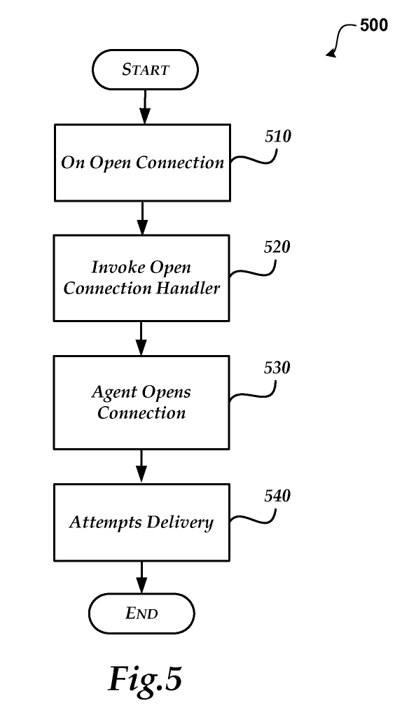

FIG. 5 illustrates a process 500 for opening a connection for a protocol supported by a user-defined agent.

After a start operation, the process flows to operation 510 where an on open connection event is raised by the messaging application.

Moving to operation 520, the open connection handler supplied by the associated user-defined agent is invoked.

Transitioning to operation 530, the agent opens one or more network connections to a remote system. According to one embodiment, the user-defined agent notifies the messaging application that the connection is open via the API.

Flowing to operation 540, the agent attempts delivery of any messages that are in the queue that is associated with the agent.

The process then flows to an end operation and returns to processing other actions.

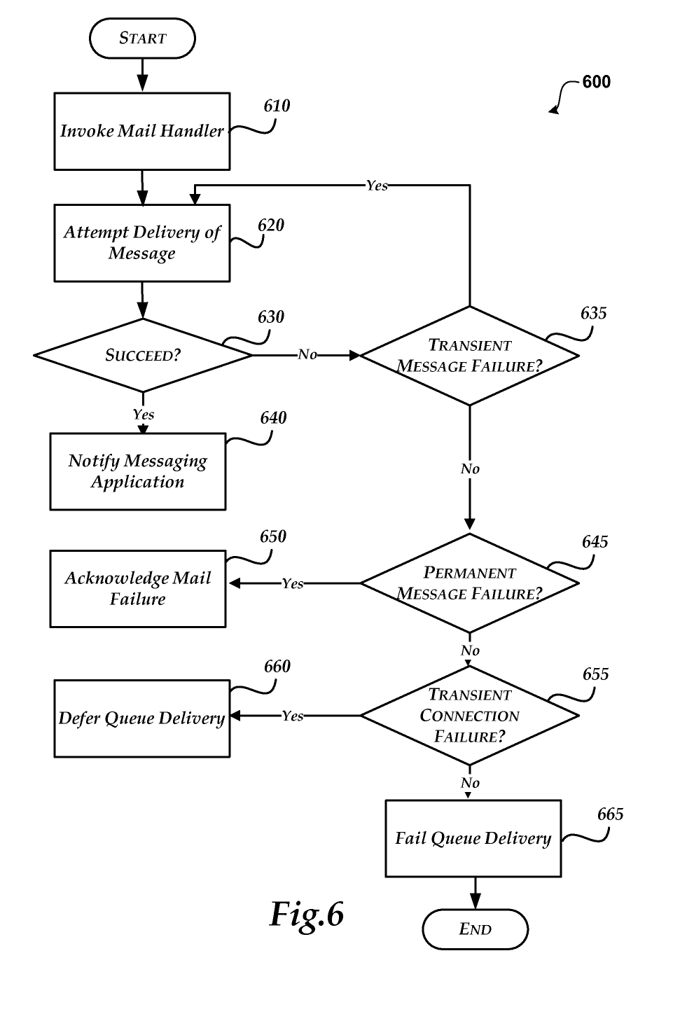

FIG. 6 shows a process for delivering messages using a user-defined agent.

After a start operation, the process flows to operation 610 where the mail handler supplied by the user-defined agent is invoked in response to a deliver mail item event raised by the messaging application. The mail handler is invoked when there is a message in the queue and the user-defined agent has already established a network connection with a remote host.

Moving to operation 620, the agent attempts to deliver the current message being processed.

Transitioning to decision operation 630, a determination is made as to whether the message was successfully delivered. When the message is successfully delivered, the process moves to operation 640 where the user-defined agent notifies the messaging application via the API that the message has been delivered successfully.

When the message is not delivered successfully, the process flows to decision operation 635, where a determination is made as to whether the message was not delivered due to a transient message failure. When there is a transient message failure, the process returns to block 620 where the message delivery is attempted. According to one embodiment, this return to attempt to deliver the message may be set to wait a predetermined amount of time.

When there is not a transient message failure, the process moves to decision operation 645 to determine whether there is a permanent message failure. When there is a permanent message failure, the process moves to operation 650 where an acknowledgement of message failure is provided to the messaging application via the API. When there is not a permanent message failure, the process moves to decision operation 655 to determine whether there is a transient connection failure.

When there is a transient connection failure, the process moves to operation 660, where the delivery of the messages within the queue for the agent is deferred for some period of time.

When there is not a transient connection failure, the process moves to operation 665, where the queue delivery is failed when the agent notifies the messaging application of the queue failure.

The process then flows to an end operation and returns to processing other actions.

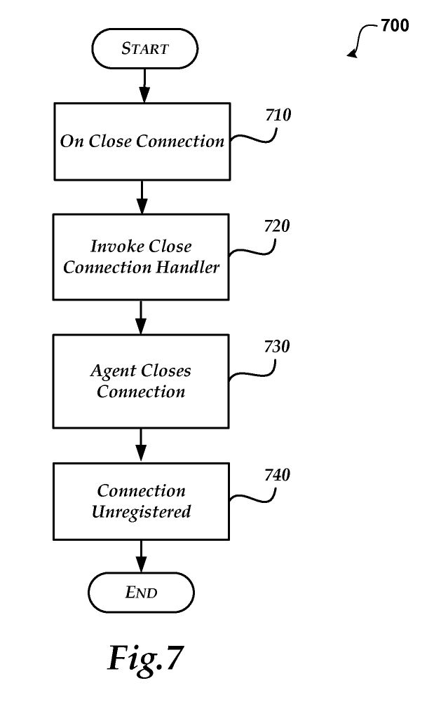

FIG. 7 illustrates a process for closing a connection that is associated with a user-defined agent.

After a start operation, the process flows to operation 710 where a close connection event is raised by the messaging application. Moving to operation 720, the close connection handler for the agent is invoked.

Flowing to operation 730, the agent closes the connection with the remote host(s). The process then moves to operation 740, where the agent via the API notifies the messaging application that the connection is closed and in response, the messaging application unregisters the connection. The process then flows to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for processing an electronic message, the method executing on a processor of a computer, comprising:
accessing a message;
selecting a connector for the message;
routing the message to the selected connector using a messaging application; and
the messaging application invoking a user-defined agent for the connector to process the message; wherein the user-defined agent provides support for unsupported protocols of the messaging application.

2. The method of claim 1, wherein the connector includes an address space property and a supported protocol property that is defined by a different party from a developer of the messaging application.

3. The method of claim 2, wherein selecting the connector for the message, comprises determining a routing address for the message and selecting the connector from a plurality of connectors that matches the address space property.

4. The method of claim 2, wherein the user-defined agent performs operations comprising delivering the message to a remote network address and notifying the messaging application of success and failure of delivery of the message.

5. The method of claim 4, wherein the notification occurs through an Application Programming Interface (API) that is associated with the messaging application.

6. The method of claim 4, wherein the user-defined agent is invoked upon an open connection event, a deliver mail event, and a close connection event that is raised by the messaging application.

7. The method of claim 4, wherein the open connection event is raised by the messaging application in response to no instances of the user-defined agent and in response to a need for more instances of the user-defined agent to handle processing of messages that are associated with the user-defined agent.

8. The method of claim 5, wherein the user-defined agent uses the API for queue management of the messages and diagnostics.

9. A computer-readable storage medium having computer-executable instructions for processing messages using a user-defined delivery agent that is associated with a messaging application, comprising:
accessing a message to be delivered using a first protocol; wherein the first protocol is unsupported by the messaging application;
selecting a connector from a group of connectors for the message;
routing the message to the selected connector; and
the messaging application invoking a user-defined agent for the connector to process the message using the first protocol; wherein the user-defined agent provides support for delivering the message using the first protocol; and
the user-defined agent utilizing an API provided by the messaging application to provide message delivery status.

10. The computer-readable storage medium of claim 9, wherein each of the connectors defines an address space and a supported protocol.

11. The computer-readable storage medium of claim 10, wherein selecting the connector, comprises determining a routing address for the message and selecting the connector that and address space that matches the routing address.

12. The computer-readable storage medium of claim 11, wherein the user-defined agent performs operations comprising delivering the message to the routing address and using functionality from the API to parse the message.

13. The computer-readable storage medium of claim 11, wherein the user-defined agent is invoked upon an open connection event, a deliver mail event, and a close connection event that is raised by the messaging application.

14. The computer-readable storage medium of claim 13, wherein the open connection event is raised by the messaging application in response to no instances of the user-defined agent and in response to a need for more instances of the user-defined agent to handle processing of messages that are associated with the user-defined agent.

15. The computer-readable storage medium of claim 13, wherein the deliver mail event is raised for a delivery of each message that is contained within a message queue for the user-defined agent.

16. A system for processing messages using a user-defined agent that extends protocol support for a messaging application, comprising:
a processor and a computer-readable medium;
an operating environment stored on the computer-readable medium and executing on the processor;
a network connection;
a message queue that is configured to store messages for delivery to a remote address;
a messaging application and a connection manager operating on a server; and configured to perform tasks, comprising:
accessing a message from the message queue;
selecting a connector for the message based on the remote address;
routing the message to the selected connector; and
invoking a user-defined agent defined by a third-party;
wherein the user-defined agent opens a connection to the remote address; delivers the message; closes the connection when delivery of the message is successful and notifies the messaging application of success relating to the delivery of the message.

17. The system of claim 16, wherein selecting the connector comprises determining a connector from a plurality of connectors that matches an address space and a protocol of the message.

18. The system of claim 16, wherein the user-defined agent is invoked by the messaging application upon an open connection event, a deliver mail event, and a close connection event that is raised by the messaging application; wherein the user-defined agent provides a handler for the open connection event, the deliver mail event, and the close connection event.

19. The system of claim 18, wherein the open connection event is raised by the messaging application in response to no instances of the user-defined agent and in response to a need for more instances of the user-defined agent to handle processing of messages that are associated with the user-defined agent.

20. The system of claim 18, wherein the deliver mail event is raised for a delivery of each message that is contained within the message queue for the user-defined agent.
